(19) United States
(12) Patent Application Publication
(10) Pub. No.: US 2024/0402740 A1
(43) Pub. Date: Dec. 5, 2024

(54) VOLTAGE REGULATOR DROOP REDUCTION MECHANISM

(71) Applicant: NVIDIA Corp., Santa Clara, CA (US)

(72) Inventors: Zhonghua Li, San Jose, CA (US); Wen-Hung Lo, Saratoga, CA (US); Michael Ivan Halfen, San Francisco, CA (US); Abhishek Dhir, Oakville (CA); Jaewon Lee, San Jose, CA (US); Jiwang Lee, San Jose, CA (US); CHUNJEN SU, Zhubei City (TW)

(73) Assignee: NVIDIA Corp., Santa Clara, CA (US)

(21) Appl. No.: 18/327,666

(22) Filed: Jun. 1, 2023

(51) Int. Cl. G05F 1/563; G05F 1/565; G05F 3/26

(52) U.S. Cl. CPC G05F 1/563; G05F 1/565; G05F 3/262

(57) ABSTRACT

Power supply circuits in which a supplemental current driver is utilized to boost the current provided by a voltage regulator. The supplementing driver detects operating conditions for providing the supplementary current, and may be trained to provide particular amounts of current in response to particular operation conditions of a circuit load.

### BACKGROUND

Voltage regulators are commonly utilized to supply a regulated voltage level to varying current loads. When a circuit makes an increased demand for current from the regulator, the regulator takes time to respond, and “voltage droop” (a drop in the supplied voltage) may occur. Voltage droop may have a negative impact on circuit performance. One common solution to reduce droop is to improve the regulator's bandwidth to reduce its response time to increases in current demand. Such solutions may come at the cost of increased regulator size and/or power consumption, e.g., using a larger or more heavily biased amplifier in the regulator.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A depicts an embodiment of a power supply system for a load 102.

FIG. 1B depicts an example of voltage droop in the regulator 104 with and without supplemented current from the driver 106.

FIG. 1C depicts a current driver in accordance with one embodiment.

FIG. 1D depicts an example of supplemental current provided to a load in response to a data signal.

FIG. 2A depicts an embodiment of a power supply system for a clock driver 202.

FIG. 2B depicts an embodiment of a power supply system for a transmitter driver 204.

FIG. 3A depicts an exemplary clock input to the load 102 and detector 108.

FIG. 3B depicts an exemplary data input to the load 102 and detector 108.

FIG. 4A depicts an embodiment of logic to control the supplemental current provided to a load.

FIG. 4B depicts an embodiment of logic to train the supplemental current provided to a load.

FIG. 5 depicts a circuit system 502 in accordance with one embodiment.

### DETAILED DESCRIPTION

Regulator voltage droop is positively correlated with sudden changes in current loading. Mechanisms are disclosed herein to utilize a current driver to supplement the current provided by a voltage regulator. The supplementing driver detects operating conditions for providing supplementary current, and is trained to provide particular amounts of current in response to particular operation conditions. The disclosed mechanisms comprise supplementary drivers, detectors, and training logic. The mechanisms may be utilized without an increase in total standby current.

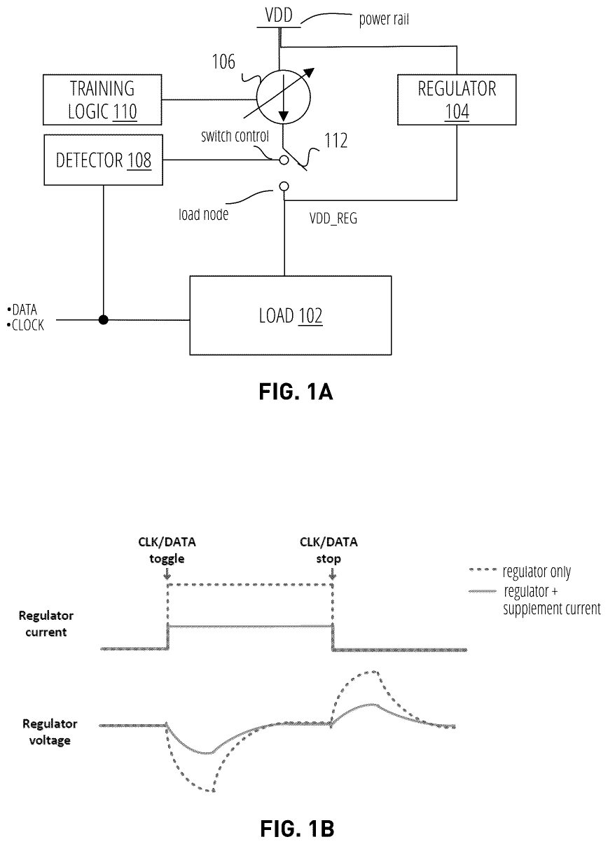

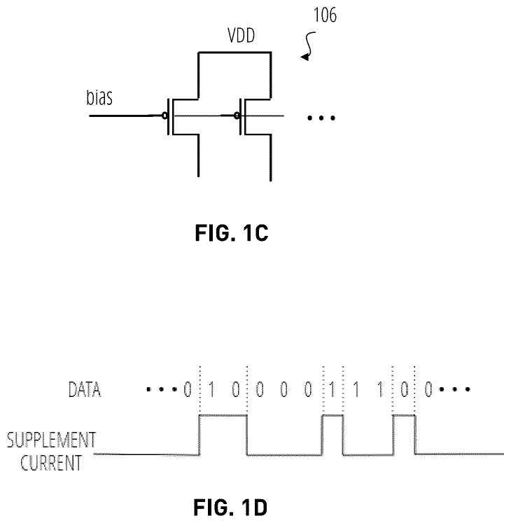

FIG. 1A depicts an embodiment of a power supply system for a load 102. By way of example, the load 102 could be a clock driver (a circuit that generates a clock signal), a data transmitter driver, a digital receiver, a graphics processing unit or computational element thereof (arithmetic unit, floating point unit, etc.), a general purpose data processor, an encryption circuit, a deep learning processor, and so on.

The system comprises a detector 108, a regulator 104, a driver 106, and training logic 110. FIG. 1B depicts an example of voltage droop in the regulator 104 with and without supplemented current from the driver 106.

The regulator 104 inputs the supply voltage VDD and provides a regulated voltage VDD_REG and current to the load 102. The driver 106 dynamically supplements the load current supplied by the regulator 104 in response to operating conditions of a CLOCK signal and a DATA signal. FIG. 1C depicts an example of the driver 106 implemented as a current mirror.

The training logic 110 calibrates the driver 106 to generate particular amounts of current in response to particular states of the CLOCK and DATA. The detector 108 monitors the CLOCK and/or DATA for state and operates a switch to apply the supplemental current from the driver 106 to the load 102. FIG. 1D depicts an example DATA signal and the incremental current response from the driver 106 in response to binary transitions (0-1 and 1-0) in the DATA signal.

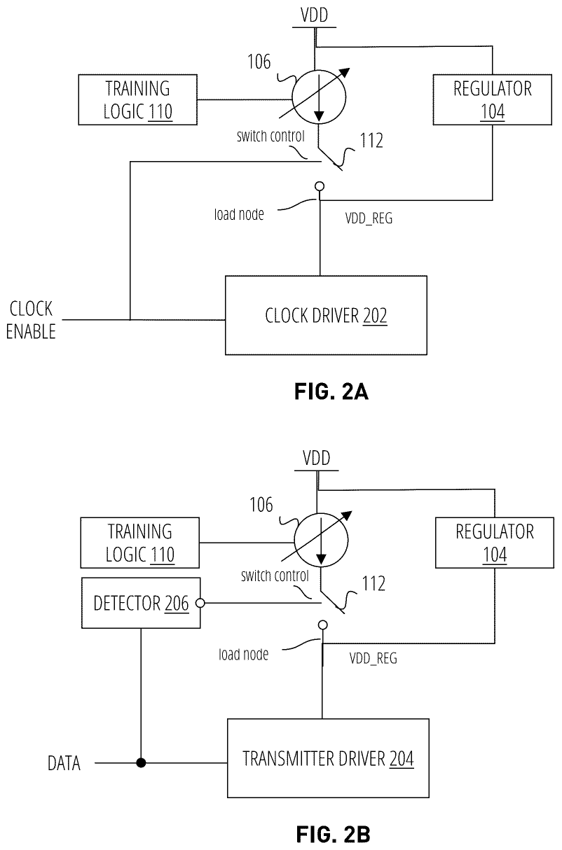

FIG. 2A depicts an embodiment of a mechanism to regulate the power supply voltage for a clock driver 202. The regulator 104 inputs the supply voltage VDD and provides a regulated voltage VDD_REG and current to the clock driver 202. The driver 106 dynamically supplements the load current supplied by the regulator 104 in response to enabling of the clock driver 202. The training logic 110 calibrates the driver 106 to generate a particular amount of current in response to enablement of the clock driver 202.

FIG. 2B depicts an embodiment of a power supply system for a transmitter driver 204, for example a transmitter driver for communicating over a bus.

The regulator 104 inputs the supply voltage VDD and provides a regulated voltage VDD_REG and current to the transmitter driver 204. The driver 106 dynamically supplements the load current supplied by the regulator 104 in response to operating conditions of a DATA signal. The training logic 110 and detector 206 operate as described above for FIG. 1A (in this specific case, the detector 206 is responsive to only the DATA).

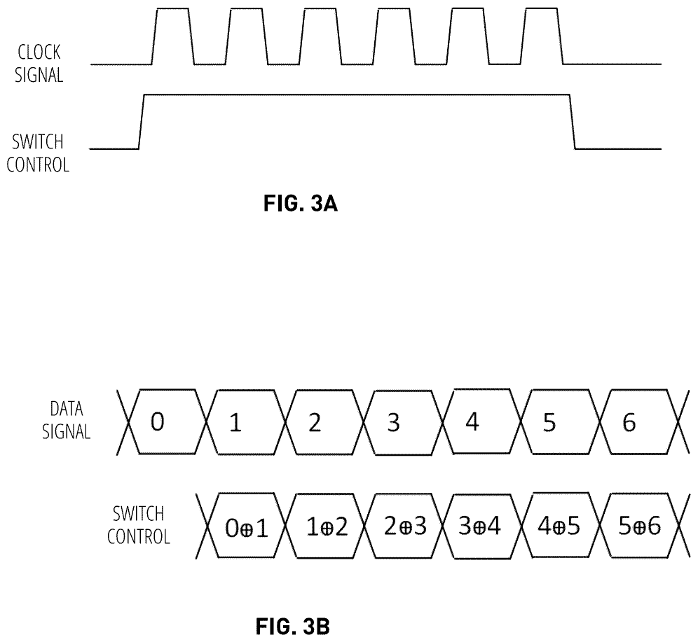

FIG. 3A depicts an exemplary clock input to the load 102 and detector 108. The switch control signal activates a clock circuit, which in turn generates a sequences of clock pulses to the load 102 and detector 108.

FIG. 3B depicts an exemplary data input to the load 102 and detector 108.

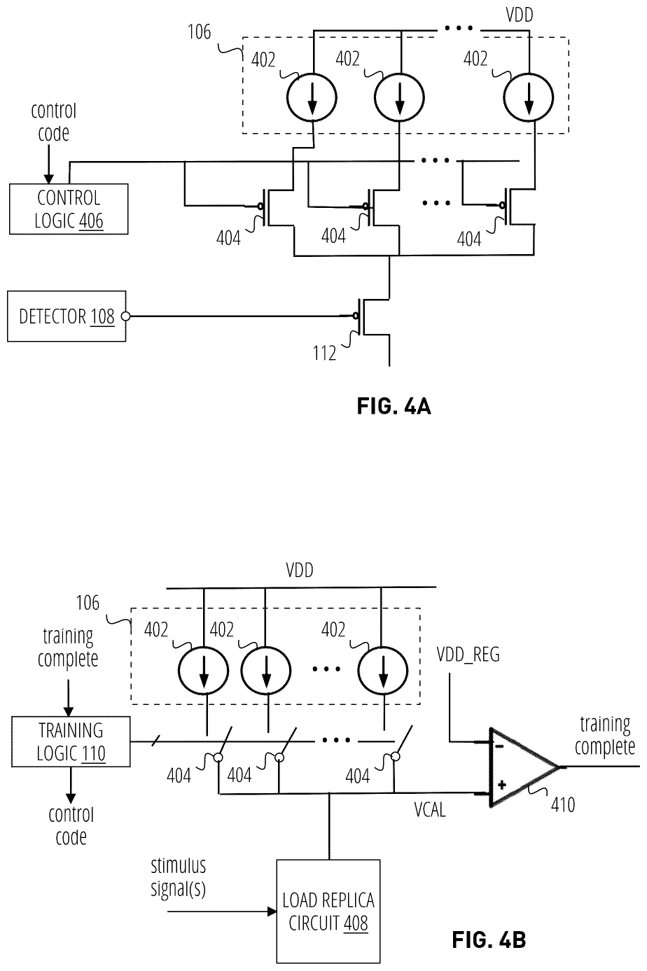

FIG. 4A depicts an embodiment of logic to control the supplemental current provided to a load. A plurality of incremental current sources 402 are coupled between the supply voltage VDD and switches 404. When operating conditions indicative of a change in load current are detected by the detector 108, the control logic 406 activates a number of the switches determined based on training to reduce/minimize the voltage droop of the regulator 104. The detector 108 also activates the switch 112 to enable the supplemental current to reach the load 102.

FIG. 4B depicts an embodiment of logic to train the supplemental current provided to a load. The base current drawn by the load replica circuit 408 is measured with the stimulus signal(s) turned off. The stimulus could be a clock signal, a data signal, and enable signal, or combinations thereof, for example. The training logic 110 sweeps through a set of digital codes. The level of the voltage VCAL increases along with digital code. When VCAL is equal or approximately equal to VDD_REG (the reference, stable load voltage), the current provided by the incremental current sources 402 activated by the code is equal or close to equal to the base current needed by the load replica circuit 408.

The stimulus signal(s) is turned on, and the training logic 110 sweeps through a set of digital codes. The level of the voltage VCAL increases along with digital code. When VCAL is equal or approximately equal to VDD_REG (the reference, stable load voltage), the current provided by the incremental current sources 402 activated by the code is equal or close to equal to the supplemental current needed by load replica circuit 408 due to a change in operating conditions (after subtracting the base current). This situation toggles the output of the comparator 410 and sends a signal to the training logic 110 (or other circuit) to send the code to the control logic 406 for setting the driver 106 strength during operation.

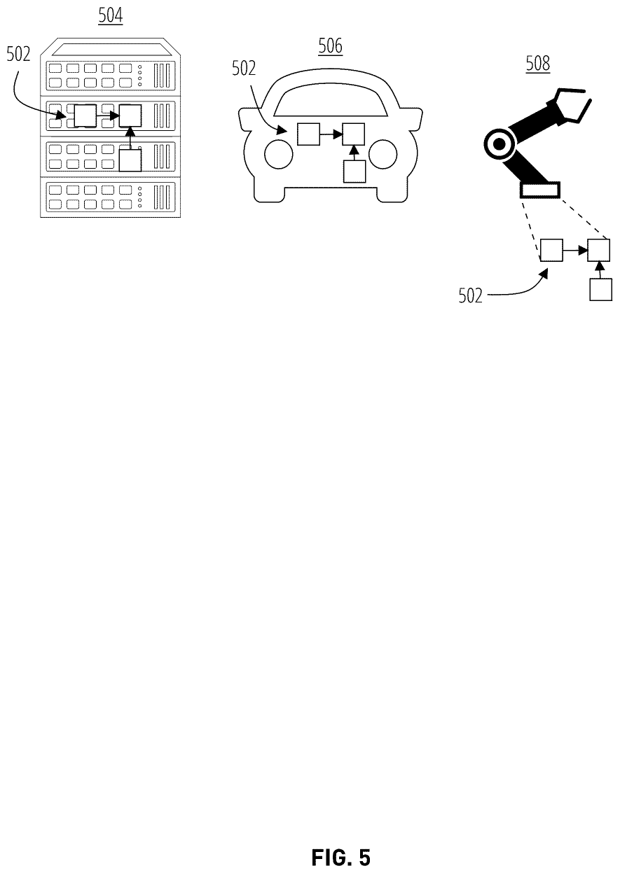

FIG. 5 depicts exemplary scenarios for use of a voltage regulating circuit system 502. A circuit system 502 regulating load voltage may be utilized in a computing system 504, a vehicle 506, and a robot 508, to name just a few examples. The circuit system 502 may comprise a voltage regulator and supplemental current driver, and optionally a detector, in accordance with the mechanisms disclosed herein.

### LISTING OF DRAWING ELEMENTS

102 load
104 regulator
106 driver
108 detector
110 training logic
112 switch
202 clock driver
204 transmitter driver
206 detector
402 incremental current source
404 switch
406 control logic
408 load replica circuit
410 comparator
502 circuit system
504 computing system
506 vehicle
508 robot

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A power supply circuit for a load, the power supply circuit comprising:
a power supply voltage regulator;
a current driver configured to supply current to a load node of a circuit in parallel with the voltage regulator; and
a switch configured to couple the current driver to the load node in response to an input signal to the load.

2. The power supply circuit of claim 1, wherein the current driver comprises a current mirror.

3. The power supply circuit of claim 2, wherein the current mirror is configured to receive a digital code to set an amount of output current.

4. The power supply circuit of claim 3, further comprising training logic configured to determine a setting for the digital code.

5. The power supply circuit of claim 1, the input signal comprising an enable signal for the load.

6. The power supply circuit of claim 1, further comprising a detector interposed between the input signal and the switch.

7. The power supply circuit of claim 6, wherein the detector comprises logic to detect a clock signal to the load.

8. The power supply circuit of claim 6, wherein the detector comprises logic to detect a data signal to the load.

9. The power supply circuit of claim 8, wherein the logic to detect the data signal to the load comprises logic to operate the switch in response to binary transitions in the data signal.

10. A power supply training circuit comprising:
a current driver comprising a plurality of incremental current sources;
a load;
training logic to sequence through a first plurality of switch settings between the current driver and the load; and
a comparator configured to receive a reference load voltage and a supply voltage generated at the load in response to current from the current driver to generate a signal to capture a digital code from the training logic corresponding to the switch settings satisfying the reference load voltage.

11. The power supply training circuit of claim 10, further comprising:
logic to:
apply a stimulus signal to the load;
sequence through a second plurality of switch settings between the current driver and the load; and
determine a digital code corresponding to the switch settings satisfying an incremental current from the current driver that sustains the reference load voltage at the load in response to the stimulus signal.

12. A circuit comprising:
a voltage regulator coupled to a power rail;
a current driver comprising a plurality of incremental current sources configured in parallel with the voltage regulator between a load and the power rail; and
a plurality of independently-operable switches configured between the incremental current sources and the load, the switches responsive to one or more of an enable signal, clock signal, and binary sequence applied to the load.

13. The circuit of claim 12, wherein the current sources comprise a current mirror.

14. The circuit of claim 13, wherein the current mirror is configured to respond to a digital code corresponding to one or more of the enable signal, clock signal, and binary sequence.

15. The circuit of claim 14, further comprising training logic configured to determine a value of the digital code.

16. The circuit of claim 12, wherein the switches are responsive to an enable signal applied to the load.

17. The circuit of claim 12, wherein the switches are responsive to a clock signal applied to the load.

18. The circuit of claim 17, wherein the switches are responsive to a binary sequence applied to the load.

19. The circuit of claim 18, wherein the switches are responsive to transitions in the binary sequence.

20. The circuit of claim 17, further comprising a detector configured to detect one or both of the clock signal and the binary sequence.
